(19) United States
(12) Patent Application Publication
(10) Pub. No.: US 2014/0212115 A1
(43) Pub. Date: Jul. 31, 2014

(54) OPTICAL DISC WITH THREE-DIMENSIONAL VIEWING DEPTH

(71) Applicant: HEWLETT PACKARD DEVELOPMENT COMPANY, L.P., Houston, TX (US)

(72) Inventors: Charles R. WEIRAUCH, Loveland, CO (US); Michael ANTHONIO, San Francisco, CA (US)

(73) Assignee: HEWLETT PACKARD DEVELOPMENT COMPANY, L.P., Houston, TX (US)

(21) Appl. No.: 13/756,218

(22) Filed: Jan. 31, 2013

(51) Int. Cl. H04N 13/00

(52) U.S. Cl. CPC H04N 13/0055
USPC 386/355

(57) ABSTRACT

An optical disc is encoded with first, second, and third sets of video data. The first set of video data is for generating a first video stream for a first eye of a viewer. The second and third sets of video data are for second and third video streams for a second eye of a viewer. The first and second sets of video data provide a first level of three-dimensional (3D) viewing depth, and the first and third sets of video data provide a second level of 3D viewing depth.

### BACKGROUND

Three dimensional (3D) display technologies have been developed to enhance viewing experience in various applications that employ video and/or graphics. In optical video disc technology (such as BLU-RAY DISC technology), multiview video coding (MVC) has been adopted to provide encoding of 3D video material stored on optical disks. MVC enables efficient encoding of stereoscopic video sequences. MVC is an extension of, and MVC encoded video is backward compatible with, the H.264 video standard.

### BRIEF DESCRIPTION OF THE DRAWINGS

For a detailed description of various examples, reference will now be made to the accompanying drawings in which:

FIG. 1 shows an optical disc that provides variable three dimensional (3D) playback depth in accordance with principles disclosed herein;

FIG. 2 shows a block diagram of an optical disc player that provides variable 3D playback depth in accordance with principles disclosed herein;

FIG. 3 shows a block diagram of a processor-based optical disc player in accordance with principles disclosed herein;

FIGS. 4A-4C illustrate examples of selection of video data sets for viewing from an optical disc in accordance with principles disclosed herein; and

FIG. 5 shows a flow diagram for a method for controlling 3D depth of video playback from an optical disc in accordance with principles disclosed herein.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The recitation “based on” is intended to mean “based at least in part on.” Therefore, if X is based on Y, X may be based on Y and any number of other factors.

### DETAILED DESCRIPTION

The following discussion is directed to various implementations of a system and method for selectably controlling the depth of three dimensional (3D) video generated by playing an optical video disc. Although one or more of these implementations may be preferred, the implementations disclosed should not be interpreted, or otherwise used, as limiting the scope of the disclosure, including the claims. In addition, one skilled in the art will understand that the following description has broad application, and the discussion of any implementation is illustrative and is not intended to intimate that the scope of the disclosure, including the claims, is limited to that implementation.

While the inclusion of 3D effects can greatly enhance the viewing of video and other media, some viewers experience discomfort, sometimes referred to as “3D fatigue,” when viewing 3D content. 3D content stored in the Blu-ray format (e.g., on a BLU-RAY DISC) is encoded using multi-view coding (MVC) as specified by the MPEG-4 video standard. In accordance with the Blu-ray format, content is authored with the 3D effects at a single depth and the viewer is forced to view the 3D images as authored, even when the 3D effect is too strong for sustained viewing by some viewers.

The optical disc and optical disc playback system disclosed herein provide relief from 3D fatigue by allowing a viewer, while viewing a 3D video, to vary the depth of the 3D images displayed and/or to disable the display of 3D effects altogether.

Video, such as a movie, consumes a great deal of storage space. Consequently, storing more than one fully authored movie on a disc is difficult. Additionally, seamlessly changing depth during a movie by switching between two separately authored movies can be problematic. FIG. 1 shows an optical disc 100 in accordance with principles disclosed herein. The optical disc 100 may be a BLU-RAY DISC. Data 102 stored on the optical disc 100 includes 3D content and playback control information (control instructions). The 3D content stored on the optical disc 100 may be encoded using multiview video coding (MVC). MVC coded video streams may not include depth mask scaling. Consequently, with such discs, depth mask scaling cannot be applied to vary the 3D depth of the video content stored on the optical disc 100.

Rather than employing depth mask scaling, the data 102 includes a plurality of sets of video data that can be processed to generate video streams that can displayed in different combinations to provide variable depth 3D viewing. A first set of video data, referred to as a main view, provides video information for presentation to a first eye (e.g., the left eye) of a viewer. A second set of video data, referred to as a dependent view, provides video information for presentation to a second eye (e.g., the right eye) of the viewer. The optical disc 100 includes a plurality of dependent view video data sets each of which provides a different depth of view when played in conjunction with the main view data set. For example, a second dependent view may provide reduced 3D depth relative to a first dependent view when played in conjunction with the main view. While playing the first dependent view, if the viewer finds the depth of view uncomfortable, the second dependent view can selectably replace the first dependent view to reduce the 3D depth of the displayed video, and reduce the 3D fatigue induced by the video.

Similarly, while playing 3D content, a viewer may eliminate 3-D effects from the displayed video by viewing a single video stream derived from one or more of the views stored on the disk (e.g., the main view) for viewing via both eyes. In some implementations of the optical disc 100, the data 102 may also include a separate two dimensional (2D) video data set that can be played in lieu of the 3D views. Accordingly, while playing 3D video, 3D effects may be eliminated by replacing playback of main and dependent views with playback of a video stream derived from a main and/or dependent view, or playback of the dedicated 2D view.

The data 102 may also include control information (control instructions) that specifies times of video playback during which 3D depth can be changed or cannot be changed. Thus, when and where within a movie 3D depth is allowed to be changed can be controlled by the disc manufacturer or content author, and changes in 3D depth requested by a viewer may be ignored or delayed based on the control information.

The control information may also specify what levels of 3D depth are allowable (i.e., may be selected by a viewer) at any particular time. Thus, if a 3D depth that is not allowed (e.g., at the requested time) by the control information is requested, then the depth change may be ignored, delayed until a time when the requested depth is allowed, or a different and allowed depth (e.g., the closest allowable depth to the requested depth) may implemented in lieu of the requested depth.

The control information may further specify a 3D depth to apply at a specified time of playback. Thus, regardless of view depth selected by a viewer, the control information may specify playback of particular views at a specified time to produce a manufacturer/content author desired 3D depth.

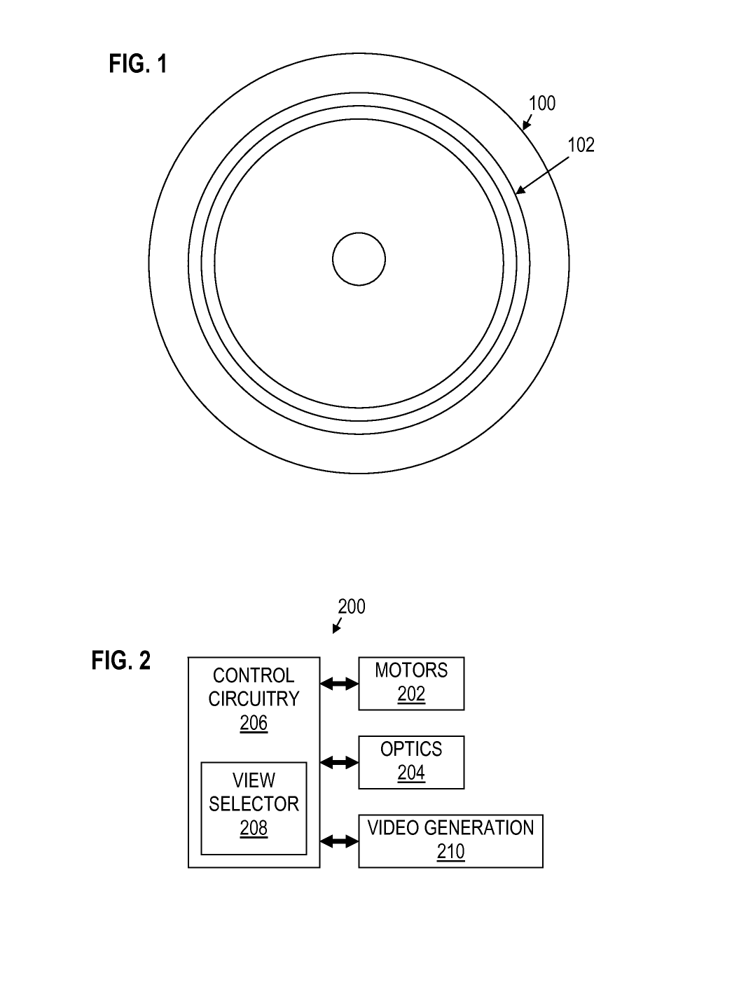

FIG. 2 shows a block diagram of an optical disc player 200 that provides variable 3D playback depth in accordance with principles disclosed herein. The player 200 plays back video content stored on the optical disc 100. The player 200 includes motors 202, optics 204, video generation 210, and control circuitry 206. The motors 202 rotate the optical disc 100, move optical elements in the player 200 to access data 102 stored on the optical disk 100, and/or move other components of the optical disc player 100. The optics 204 include a light source, lenses, etc. The video generation circuitry 210 generates video signals based on the video data sets read from the optical disc 100 for provision to a video display device. The video generation circuitry 210 may include a video decoder and other components.

The control circuitry 206 controls the operation of the motors 202, the optics 204, the video generation circuitry 210, and other components of the player 200 (such as audio decoders, power sources, displays, user interface logic, etc.) that have been omitted from FIG. 2 in the interest of clarity. The control circuitry 206 includes a view selector 208 that selects which of the video data sets (i.e. views) stored on the optical disc 100 is played, and to which eye of the viewer the video streams generated from the selected views are presented.

The view selector 208 may provide a user interface that allows a viewer to select and/or change the 3D depth of the video to be presented to the viewer. The view selector 208 may allow a user to select a 3D depth before and/or during playback of 3D video content. The view selector 208 may provide 3D depth options from which to select based on the 3D depths provided by the different video data sets stored on the optical disc 100, and/or the 3D depth restrictions specified by the control information stored on the optical disc 100.

Based on a depth selection value entered by the viewer and/or the control information provided to the view selector 208 from the optical disc 100, the view selector 208 selects the view(s) from the disc 100 to process for presentation to the viewer and selects the eye(s) of the viewer to which to present the video stream(s) generated based on the selected view(s).

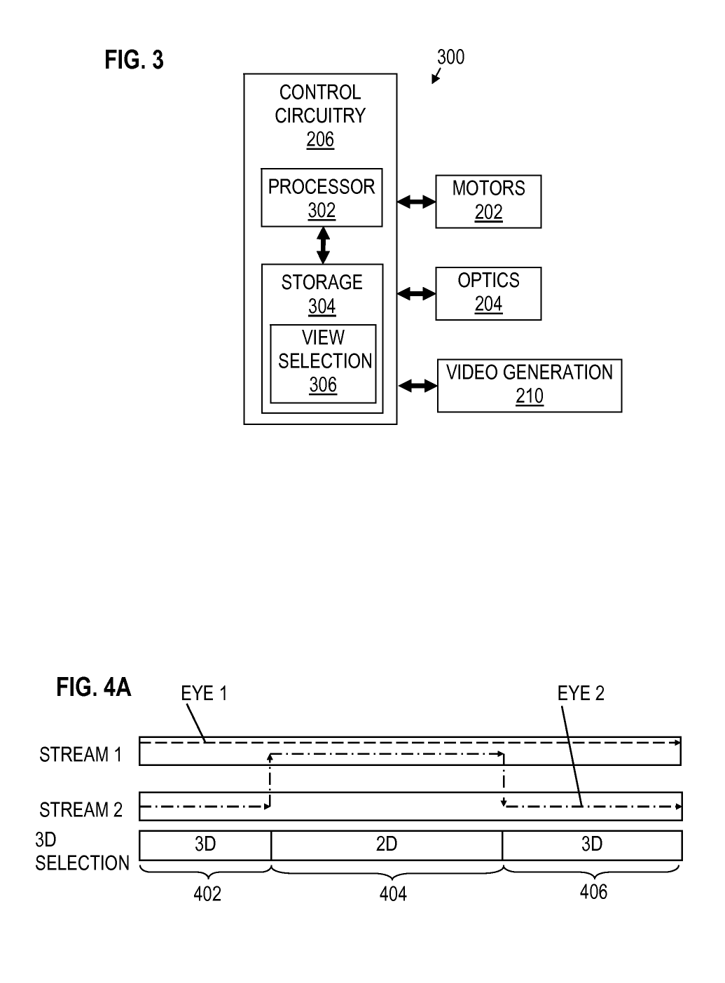

FIG. 3 shows a block diagram of a processor-based optical disc player 300 in accordance with principles disclosed herein. The optical disc player 300 is an implementation of the optical disc player 200 of FIG. 2. In the optical disc player 300, the view selector 208 and other portions of the control circuitry 206 are implemented as a processor 302 coupled to storage 304. The processor 302 may be, for example, a general-purpose microprocessor, digital signal processor, microcontroller, or other device configured to execute instructions for performing the video stream selection operations disclosed herein. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

The storage 304 stores instructions that the processor 302 executes to perform the view selection functions disclosed herein. The storage 304 is a non-transitory computer-readable storage device. A computer-readable storage device may include volatile storage such as random access memory, non-volatile storage (e.g., a hard drive, an optical storage device (e.g., CD or DVD), FLASH storage, read-only-memory), other non-transitory storage media, and combinations thereof. Processors execute software instructions. Software instructions alone are incapable of performing a function. Therefore, in the present disclosure, any reference to a function performed by software instructions, or to software instructions performing a function is simply a shorthand means for stating that the function is performed by a processor executing the instructions.

The storage 304 includes a view selection module 306. The view selection module 306 includes instructions that the processor 302 executes to perform the view selection operations disclosed herein. The storage 302 may also store other data, such as control information read from the optical disc 100, video data read from the optical disc 100, user entered 3D depth selection information, etc. Thus, the view selector 208 may comprise the processor 302 and the view selection module 306. Some implementations of the view selector 208 may include and/or consist of dedicated circuitry that performs the view selection functions described herein.

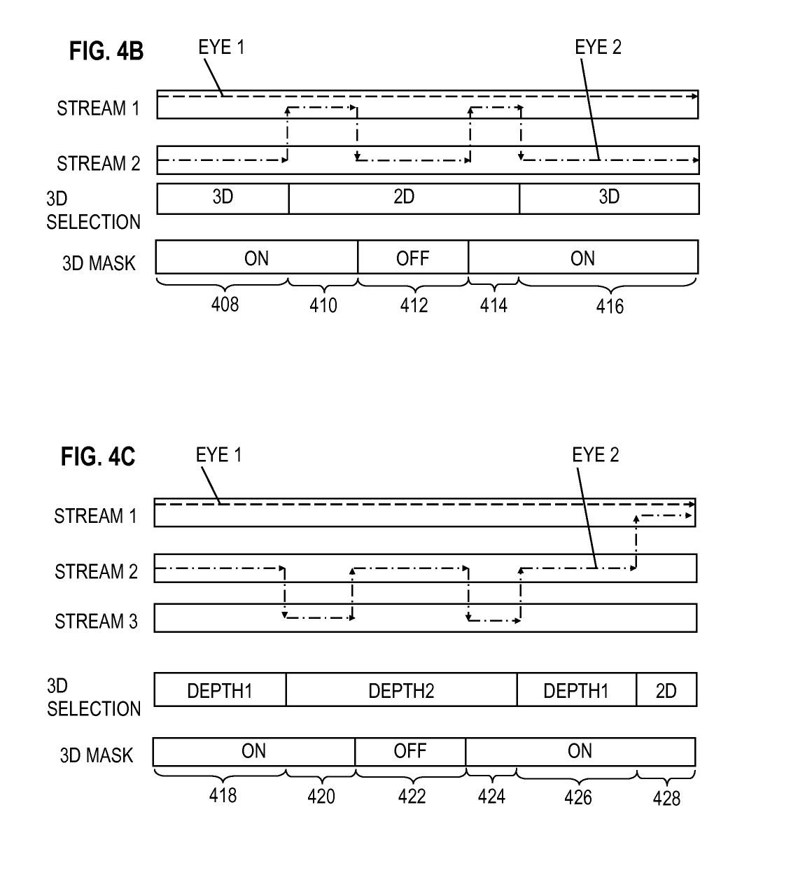

FIGS. 4A-4C illustrate exemplary selection of views from the optical disc 100 by the view selector 208 in accordance with principles disclosed herein. FIG. 4A shows two video streams, stream 1 and stream 2, decoded based on the views read from the optical disc 100 for presentation to a viewer. Stream 1 may be derived from the main view and stream 2 may be derived from a dependent view (and the main view). During time interval 402, the viewer has selected to view 3D video and the view selector 208 generates video stream 1 for eye 1 (e.g., the left eye) of the viewer, and generates stream 2 for eye 2 (e.g., the right eye) of the viewer. At the end of time interval 402, the viewer selects 2D viewing of the video, and the view selector 208 presents video stream 1 to both eye 1 and eye 2 of the viewer during time interval 404. During interval 404, and other intervals of 2D viewing, the view selector 208 may cause shutters of both lenses of 3D viewing glasses to remain open. During 2D viewing, the view selector 208 may cause the disc player 200 to decode only the video data set needed for generation of the 2-D video stream. Toward the end of time interval 404, the viewer again selects viewing of 3D video, and the view selector 208 presents video stream 1 to eye 1 of the viewer, and presents video stream 2 to eye 2 of the viewer during time interval 416.

FIG. 4B shows two video streams, stream 1 and stream 2, decoded from the views read from the optical disc 100 for presentation to a viewer. Stream 1 may be generated from the main view and stream 2 may be generated based on a dependent view. FIG. 4B illustrates the interaction of 3D mask information read from the optical disc 100 as part of the control information provided by the disc 100 with viewer depth selection. The 3D mask information specifies the playback times at which requested viewer depth changes are effective, and may specify particular 3D depths to be implemented at a given time. During time interval 408, the viewer has selected to view 3D video and the view selector 208 presents video stream 1 to eye 1 (e.g., the left eye) of the viewer, and presents stream 2 to eye 2 (e.g., the right eye) of the viewer. At the end of time interval 408, the viewer selects 2D viewing of the video. The 3D mask allows user depth selection during interval 410, and the view selector 208 presents video stream 1 to both eye 1 and eye 2 of the viewer during time interval 410.

Toward the end of time interval 410, the 3D mask information prohibits implementation of viewer depth selection and/or requires presentation of 3D video (e.g., at a specified depth). Accordingly, the view selector 208 overrides the viewer's 2D selection and presents video stream 1 to eye 1 of the viewer, and presents stream 2 to eye 2 of the viewer during time interval 412. At expiration of time interval 412 the 3D mask information again allows user depth selection, and view selector 208 reverts to 2D presentation of video (as in interval 410) during time interval 414. Near the end of time interval 414 the viewer again selects viewing of 3D video, and the view selector 208 presents video stream 1 to eye 1 of the viewer, and presents stream 2 to eye 2 of the viewer during the time interval 416.

FIG. 4C shows three video streams, stream 1, stream 2, and stream 3, decoded from the views read from the optical disc 100 for presentation to a viewer. Stream 1 may be decoded from the main view and streams 2 and 3 may be decoded from dependent views. The view selector 208 may cause the disc player 200 to decode only the views used to produce video streams being displayed. FIG. 4C further illustrates the interaction of 3D mask information read from the optical disc 100 as part of the control information provided by the disc 100 with viewer depth selection. During time interval 418, the viewer has selected to view 3D video at a first depth (Depth1) and the view selector 208 presents video stream 1 to eye 1 (e.g., the left eye) of the viewer, and presents stream 2 to eye 2 (e.g., the right eye) of the viewer to provide the selected 3D video depth. At the end of time interval 418, the viewer selects to view 3D video using a different depth of view (Depth2), and in response the viewer's selection, the view selector 208 presents video stream 1 to eye 1 of the viewer, and presents stream 3 to eye 2 of the viewer.

While viewing video streams 1 and 3, at the start of time interval 422, the 3D mask information changes and prohibits implementation of viewer depth selection, and/or prohibits use of 3D Depth2, and/or requires use of 3D Depth1. As a result, the view selector 208 presents video stream 1 to eye 1 of the viewer, and presents video stream 2 to eye 2 of the viewer during time interval 422. At the end of time interval 422, the 3D mask information allows implementation of viewer depth selection and/or use of Depth2 and the view selector 208 again presents video stream 1 to eye 1 of the viewer and presents video stream 3 to eye 2 of the viewer during time interval 424.

At the end of time interval 424, the viewer selects to return to display of 3D video using Depth1, and the view selector 208 presents video stream 1 to eye 1 of the viewer, and presents video stream 2 to eye 2 of the viewer during time interval 426. At the end of time interval 426, the viewer selects 2D viewing of the video, and the view selector 208 presents video stream 1 to both eye 1 and eye 2 of the viewer during time interval 428.

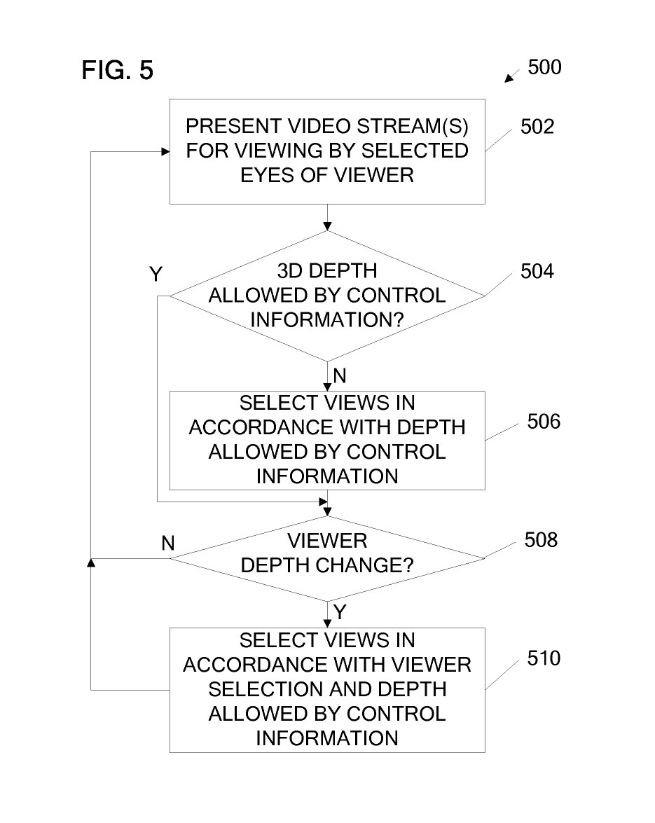

FIG. 5 shows a flow diagram for a method 500 for controlling 3D depth of video playback from an optical disc 100 in accordance with principles disclosed herein. Though depicted sequentially as a matter of convenience, at least some of the actions shown can be performed in a different order and/or performed in parallel. Additionally, some implementations may perform only some of the actions shown. At least some of the operations of the method 500 can be performed by a processor (e.g., processor 302) executing instructions read from a computer-readable medium (e.g., storage 304).

In block 502, the optical disc player 200 is decoding video streams from the video data (views) read from the optical disc 100 and presenting the video streams for viewing by selected eyes of the viewer. For example, the optical disc player 200 may alternately display images of each of two video streams (e.g., derived from a main and dependent view) and synchronize the display with the opening and closing of shutters of 3D viewing glasses worn by a user, thereby displaying each video stream to a selected eye. The video streams presented may be selected based on a 3D depth selected by the viewer where the optical disc 100 includes a plurality of dependent views each corresponding to a different 3D depth when presented in conjunction with a main view video stream.

In block 504, the optical disc player 200 determines whether the currently provided 3D depth is in accordance with 3D depth(s) presently allowed by control information read from the optical disc 100. The control information read from the optical disc 100 may specify what 3D depths are allowable for use at a given time.

If the 3D depth provided by the video streams currently being presented is not in accordance with the 3D depth(s) specified by the control information, then, in block 506 the optical disc player 200 selects views for decoding into video streams for presentation to the viewer in accordance with the 3D depth(s) allowed by the control information.

In block 508, the optical disc player 200 determines whether the viewer has selected a 3D depth different from the 3D depth provided by the video streams currently selected for presentation. If the 3D depth has not been changed by the viewer then playback continues in block 502.

If the viewer has requested a change in 3D depth, then in block 510 the optical disc player selects views from the optical disc 100 for decoding into video streams for playback in accordance with the viewer's selected depth and the depth(s) allowed by the control information read from the optical disk 100. The generated video streams are presented for viewing in block 502.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. An optical disc encoded with data comprising:
a first set of video data for generating a first video stream for a first eye of a viewer;
a second set of video data for generating a second video stream for a second eye of the viewer;
a third set of video data for generating a third video stream for the second eye of the viewer; and
first control information that causes an optical disc player to enable interchange of playback of the second and third video streams, in conjunction with playback of the first video stream, at a time indicated by the first control information.
wherein the first and second sets of video data, provide a first level of three-dimensional (3D) viewing depth, and the first and third sets of video data provide a second level of 3D viewing depth.

2. The optical disc of claim 1, further comprising second control information that causes the optical disk player to disable viewer selection of one of the second and third sets of video data at a time specified by the second control information.

3. The optical disc of claim 1, further comprising second control information that causes the optical disc player to playback one of the second and third sets of video data specified by the second control information in conjunction with the first set of video data at a time specified by the second control information.

4. The optical disc of claim 1, further comprising second control information that causes the optical disc player to enable playback of the first set of video data for viewing via the second eye, in lieu of the either of the second and third sets of video data, at a time specified by the second control information.

5. The optical disc of claim 1, further comprising:
a fourth set of video data for generating a fourth video stream for two-dimensional viewing via the first and second eyes of the viewer; and
second control information that causes the optical disc player to enable playback of the fourth set of video data for viewing via the first and second eye, in lieu of the either of the first, second and third sets of video data, at a time specified by the second control information.

6. An optical disc player, comprising:
a motor to rotate an optical disc; and
a view selector to:
select a first set of video data read from the optical disc for generation of a first video stream for presentation to a first eye of a viewer;
select, based on a three-dimensional (3D) depth selection value provided to the optical disc player by a viewer, one of a second set of video data and a third set video data read from the optical disc for generation of a second video stream for presentation to a second eye of the viewer;
wherein the first video stream and the second video stream are viewable together to provide a first 3D viewing depth; and the first video stream and the third video stream are viewable together to provide a second 3D viewing depth.

7. The optical disc player of claim 6, wherein the view selector is to:
access control information read from the optical disc; and
determine, based on the control information, at what times during video playback interchange of playback of the second and third sets of video data, in conjunction with playback of the first set of video data is enabled.

8. The optical disc player of claim 6, wherein the view selector is to:
access control information read from the optical disc; and
determine, based on the control information, at what times during video playback one the second and third sets of video data specified by the control information is to be played back in conjunction with the first set of video data.

9. The optical disc player of claim 6, wherein the view selector is to:
access control information read from the optical disc; and
determine, based on the control information, at what times during video playback, selection of the first set of video data for generation of a video stream for presentation to the second eye is enabled.

10. The optical disc player of claim 9, wherein the view selector is to maintain shutters of 3D viewing glasses in an open position while the first set of video data is processed for viewing via the first eye and the second eye.

11. The optical disc player of claim 6, wherein the view selector is to select a fourth set of video data read from the optical disc for generation of a fourth video stream for presentation to the first eye and the second eye of the viewer, the selection of the fourth set based on at least one of a 3D depth selection value entered by the viewer and control information read from the optical disc that specifies whether 3D playback is permitted.

12. A method, comprising:
decoding a first video stream from video data read from an optical disc and presenting the first video stream for viewing via a first eye of a viewer;
decoding one of a second video stream and a third video stream from the video data read from the optical disc and presenting the one of the second video stream and the third video stream for viewing via a second eye of the viewer;
selecting the one of the second and third video streams to decode based on a three-dimensional (3D) depth selection value provided by the viewer;
wherein the first video stream and the second video stream are viewable together to provide a first 3D viewing depth; and the first video stream and the third video stream are viewable together to provide a second 3D viewing depth.

13. The method of claim 12, further comprising:
reading control information from the optical disc; and
determining, based on the control information, at what times during video playback interchange of decoding of the second and third streams, in conjunction with decoding of the first stream is enabled.

14. The method of claim 12, further comprising:
reading control information from the optical disc; and
determining, based on the control information, at what times during video playback one the second and third streams specified by the control information is to be decoded from the video data in conjunction with the decoding of the first stream.

15. The method of claim 12, further comprising:
reading control information from the optical disc; and
determining, based on the control information, at what times during video playback selection of the first stream for viewing via the second eye, in lieu of the either of the second and third streams is enabled.

16. The method of claim 12, further comprising maintaining shutters of 3D viewing glasses in an open position while the first stream is viewed via the first eye and the second eye.

17. The method of claim 12, further comprising:
decoding a fourth video stream from video data read from the optical disc and presenting the fourth video stream for viewing via the first eye and the second eye of the viewer;
selecting to decode the fourth video stream based on a three-dimensional (3D) depth selection value entered by the viewer; and
reading control information from the optical disc that specifies times during video playback at which decoding of the fourth stream for viewing via the first and second eye, in lieu of the either of the first, second and third streams is enabled;
wherein the fourth video stream is a stream of two-dimensional video.

18. The method of claim 12, further comprising rendering a user interface through which the viewer enters the 3D depth selection value.
